(19) United States
(12) Patent Application Publication
(10) Pub. No.: US 2014/0073426 A1
(43) Pub. Date: Mar. 13, 2014

(54) CONFIGURABLE CELEBRATION FOR A GAMING TERMINAL, SYSTEM AND METHOD

(71) Applicant: Bally Gaming, Inc, Las Vegas, NV (US)

(72) Inventors: Pravinkumar Patel, Las Vegas, NV (US); Anthony E. Green, Henderson, NV (US); Marvin A. Hein, Las Vegas, NV (US)

(73) Assignee: Bally Gaming, Inc, Las Vegas, NV (US)

(21) Appl. No.: 14/079,462

(22) Filed: Nov. 13, 2013

Related U.S. Application Data
(63) Continuation of application No. 11/751,501, filed on May 21, 2007.
Application No. 11/751,501 is a continuation-in-part of application No. 11/176,432, filed on Jul. 6, 2005, now abandoned.

(51) Int. Cl. G07F 17/32

(52) U.S. Cl. CPC G07F 17/3211
USPC 463/31

(57) ABSTRACT

Configurable celebration gaming terminals, systems and methods are disclosed. In one embodiment, the configurable celebration system comprises a first data storage device defining one or more celebration activities and a second data storage device defining more triggering events. A library of celebration bindings associates triggering events with celebration activities, such that upon the occurrence of a particular triggering event, the associated celebration activity is activated. Additionally, a configuration component provides a casino operator interface for configuring at least one of the celebration activities, triggering events, binding parameters, or a combination thereof.

### CROSS-REFERENCE TO RELATED APPLICATIONS

This application is a continuation application of prior filed U.S. patent application Ser. No. 11/751,501 filed May 21, 2007 and titled “Configurable Celebration System” which is a continuation-in-part of prior filed and now abandoned U.S. patent application Ser. No. 11/176,432 filed Jul. 6, 2005 and titled “Hierarchy of Celebration Graphics” and is related to prior filed and now abandoned U.S. patent application Ser. No. 11/751,587 filed May 21, 2007 and titled “Method for Configuring Celebration Activity”.

### BACKGROUND

Casinos provide a variety of wagering games and devices to attract casino patrons. New games and game features are continuously developed and added to the casino floor in the hopes of captivating and maintaining player interest. In particular, gaming machines have been developed with various components and features to enhance the gaming experience for casino patrons.

Generally, gaming machines involve achieving a combination of winning symbols to receive an award or prize. Typically, the player places a bet or wager to activate the game. If the game result is a winning combination, the player is paid cash or some other sort of value, such as extra games or credits. In many games, the gaming machine presents an additional feature to celebrate the winning combination. Typically this celebration activity may include a special symbol or graphic to commemorate the win. Additionally, some gaming machines will also incorporate lighting and/or sound into the celebration activity.

The current gaming machines are manufactured with a fixed set of pre-defined celebration activities, which may be limited in their capabilities. Typically, the various parameters associated with the celebration activity cannot be altered or reconfigured by the casino or by casino personnel. Most often, the celebration activities relate to the game theme or a paytable. In order to promote continued player excitement, it would be advantageous to reconfigure various aspects of the celebration activities, thereby allowing the casino to present new and exciting celebrations to the player. The capability to change the celebration activities would increase player excitement and continue to maintain player interest in the gaming machine. Therefore, what is needed is a method and system to allow for implementation of new celebration concepts on one or more existing gaming devices.

### SUMMARY

Briefly, and in general terms, various embodiments are directed to a system and method providing configurable celebration activity in a casino gaming system. One embodiment provides a configurable celebration system for use with a casino gaming system. The casino gaming system includes more than one gaming machine connected via a network connection, and each gaming machine provides one or more games for play. The configurable celebration system comprises a first storage means accessible to the casino gaming system and a second storage means accessible to the casino system. The first storage means defines one or more celebration activities, wherein each celebration activity includes one or more celebration features. The second storage means defines one or more triggering events, wherein one or more of the triggering events activate a celebration activity. Additionally a library of celebration bindings associates a particular triggering event with a particular celebration activity, such that upon the occurrence of a particular triggering event, the associated celebration activity is activated. A configuration component provides a casino operator interface for configuring at least one of the celebration activities, triggering events, binding parameters, or a combination thereof.

Another embodiment is directed to a casino gaming system comprising one or more gaming machines connected to a back end server system via a network connection, where each gaming machine provides one or more games for play. A first storage means is operatively connected to one or more gaming machines and stores one or more celebration activities. The celebration activities are configurable by a casino operator. Additionally, a second storage means is operatively connected to the one or more gaming machines and stores one or more triggering events. One or more of the triggering events are configurable by a casino operator. A binding means is in communication with the first storage means and the second storage means. The binding means associates a particular triggering event with a particular celebration activity, such that when the particular triggering event occurs the associated particular celebration activity is presented on one or more gaming machines. A configuration component is operatively to—connected the back end server, and the configuration component allows a casino operator to configure at least one of the celebration activities, triggering events and binding activities.

Other features and advantages will become apparent from the following detailed description, taken in conjunction with the accompanying drawings, which illustrate by way of example, the features of the various embodiments.

### BRIEF DESCRIPTION OF THE DRAWING

FIG. 1 is an illustration of a gaming machine for use with an embodiment of a configurable celebration system.

FIG. 2 is a table listing example celebration figures and associated parameters for use with an embodiment of a configurable celebration system.

FIG. 3 is a table listing example event activities and associated parameters for use with an embodiment of a configurable celebration system.

FIG. 4 is an illustration of a casino gaming system for use with an embodiment of a configurable celebration system.

FIG. 5 is an illustration of multiple gaming machine displays presenting various celebration activities.

FIG. 6 is an example hierarchical listing of celebration features based on defined ranges of payout values.

FIG. 7 is another example hierarchical listing of celebration features based on defined ranges of payout values.

FIG. 8 is an illustration of various gaming machine displays presenting various celebration activities.

FIG. 9 is an illustration of a gaming machine for use with an embodiment of a configurable celebration system.

### DETAILED DESCRIPTION

Various embodiments disclosed herein are directed to providing a gaming system having additional entertainment features. More particularly, various embodiments are directed to a configurable celebration system for use in a gaming system. Additionally, the configurable celebration system allows a casino to configure various aspects of game celebrations, such as determining the particular features presented to a player during the celebration activity, as well as defining the various events that trigger the activation of celebration activity. Embodiments of the system and method are illustrated and described herein, by way of example only, and not by way of limitation.

Typically, celebrations are entertaining experiences incorporated by casinos to increase player interest. For example, gaming machines present various types of celebration activity during game play to enhance the player game experience. In one embodiment, the celebration activity is presented to a player, after the occurrence of a particular, specific event. For example, the celebration activity may be presented after a winning outcome on a gaming machine to commemorate and celebrate the win. The celebration activity may include various features such as, but not limited to, visual video presentations, audio presentations, multimedia presentations, lighting effects, general device control, and sending and receiving network messages. Further, the celebration activity may include one or more of the aforementioned features, in any combination. In particular, the visual video presentation feature may include, but is not limited to, such examples as two-dimensional images, three-dimensional images, animated graphics, photographs, and video presentations. The sound presentation feature may include, but is not limited to, music, dialogue, and sound effects. Examples of general device control include, but are not limited to, mechanical or motion effects, tactile responses, vibration effects, temperature changes, fog or mist effects, and scent effects.

In various embodiments, the celebration features presented during celebration activities are stored in a memory device (not shown). By way of example, but not by limitation, such devices include external memory devices, hard drives, CD-ROMs, DVDs, and flash memory cards. In one embodiment, the features of the celebration activities are stored on a casino back end system. In an alternate embodiment, the features of the celebration activities are stored in a remote storage device. In one embodiment, the remote storage device is housed in a remote server. The gaming machine may access the remote storage device via a network connection, including but not limited to a local area network connection, a TCP/IP connection, a wireless connection, or any other means for operatively networking components together. Optionally, features of the celebration activities are stored in a memory device (not shown) for use with a gaming machine.

The duration of the celebration activity may vary. In one embodiment, the celebration activity may be presented for a fixed duration of time. For example, the casino may configure the presentation to last for a fixed time of 15 seconds. Those skilled in the art will appreciate that the fixed time duration may be of any length. Optionally, in an alternate embodiment, the celebration activity may terminate upon the completion of a feature. For example, if the celebration activity includes the presentation of a video clip, then the celebration activity may terminate upon the completion of the video clip. Additionally, in an optional embodiment, the celebration activity may run continuously until a termination event occurs. Additionally, in an alternate embodiment, the player may have the ability to terminate the celebration activity. In another example embodiment, the player may postpone the presentation of the celebration activity. For example, in one scenario, a player is visiting the casino with family and friends. If the player is playing a game alone and the presentation of a celebration activity is triggered, the player can delay the presentation in order to share the celebration with his family and friends.

The celebration activity may be presented on or around the gaming machine or on associated devices such as centrally located overhead monitors, seismic generators, or motion effects on the patron chair. The celebration activity may be personalized to include the player's name, picture or other personal data. Optionally, the celebration activity may be configured to include information pertaining to current events, news, or weather information. Additionally, in an optional embodiment, the celebration activity may be configured to include a seasonal or holiday related message. The celebration activity may be presented to a single individual such as the patron, or it may be presented to groups of individuals.

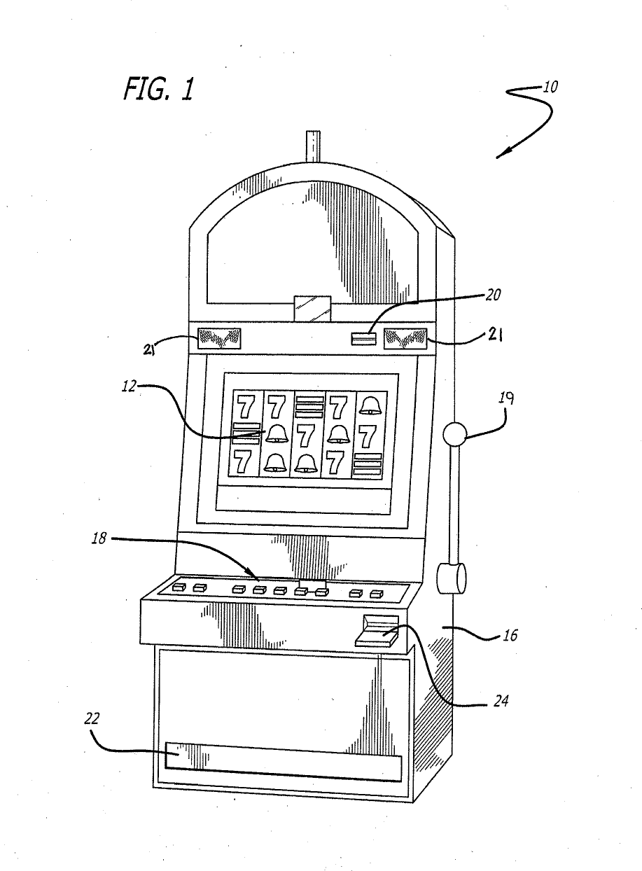

Referring now to the drawings, wherein like reference numerals denote like or corresponding parts throughout the drawings and, more particularly to FIGS. 1-9, there are shown various embodiments of a method and system directed to providing configurable celebration activity in a casino gaming system.

Referring now to FIG. 1, a gaming machine 10 having a display 12 is shown. In various embodiments, the display 12 is a viewing area that presents one or more games of chance such as, but not limited to, mechanical slots, video slots, video poker, video blackjack, video keno, video roulette, or Class II bingo. In alternate embodiments, the display 12 may present games of skill or games of chance involving various levels of player skill. Additionally, one or more visual features of a celebration activity may be presented in the display 12.

In some embodiments, the display 12 is a video display such as, but not limited to, a CRT (cathode ray tube), or a thin-panel display. Examples of thin-panel displays include plasma, LCD (liquid crystal display), electroluminescent, vacuum fluorescent, field emission, or any other types of thin panel displays known or developed in the art. Additionally, the video picture may be presented in either a portrait or landscape orientation and utilize standard or widescreen dimensions. Optionally, the game display 12 may also include a touch screen or touch glass system (not shown).

In various embodiments, the gaming machine 10 may be a mechanical slot machine, video slot machine, video poker machine, keno machine, video blackjack machine, or a gaming machine offering one or more of the above-described games. The main cabinet 16 of the gaming machine 10 is a self-standing unit that is generally rectangular in shape. In other embodiments, the cabinet (not shown) may be a slant-top, bar-top, or table-top style cabinet. However, any shaped cabinet may be used with any embodiment of the gaming machine 10 and sized for a player to be able to sit or stand while playing a game. Additionally, the cabinet 16 may be manufactured with reinforced steel or other rigid materials that are resistant to tampering and vandalism.

In some embodiments, the gaming machine 10 also comprises a gaming mechanism (not shown), which provides a game for play on the gaming machine 10. In other embodiments, the gaming mechanism provides a plurality of games for play on the gaming machine 10. In one embodiment, the games available for play are stored on the gaming machine 10. Optionally, in an alternate embodiment, the available games are stored on a network server operatively connected to the gaming machine 10, wherein the gaming machine 10 downloads the game.

Additionally, the gaming machine 10 may further include a plurality of player-activated buttons 18, which may be used for numerous functions such as, but not limited to, selecting a wager denomination, selecting a number of games to be played, selecting a wager amount per game, initiating a game, or cashing out money from the gaming machine 10. The buttons 18 function as input mechanisms and may include mechanical buttons, electromechanical buttons or touch screen buttons. Optionally, handle 19 may be “pulled” by a player to initiate a game. Additionally, one or more of the player-activated buttons 18 may be used as an interface mechanism in conjunction with the presentation of a celebration activity. More particularly, one or more of the player-activated buttons 18 may be used by a player to terminate the presentation of a celebration activity.

In one embodiment, the main cabinet 16 houses a game management unit (not shown) that includes a CPU, circuitry, and software for receiving signals from the player-activated buttons 18 and a handle 19, operating the games, and transmitting signals to the respective game display 12 and speakers 21. In one embodiment, one or more audio features of a presented celebration activity may output audio to the speakers 21. The speakers 21 may be operatively connected to an amplifier (not shown). Alternately, the speakers 21 may be self-amplified. Optionally, the speakers 21 may be component speakers with separate tweeter, midrange, and subwoofer to provide better sound imaging to the gaming machine patron. In yet another embodiment, the speakers 21 may be full range speakers (e.g., two-way, three-way or 4-way speakers). Optionally, various audio files for use with one or more audio features may be stored on the gaming machine 10.

In another embodiment, a seat (not shown) is operatively connected to the gaming machine. In one embodiment, one or more celebration activities include a vibration effect. In particular, the operatively connected seat will vibrate during the celebration activity. Additionally, in some embodiments, the celebration activity includes additional features in combination with the vibrating seat effect. For example, in one embodiment, a video may be displayed on the display 12 while the seat (not shown) vibrates. Optionally, sound effects may be output from the speakers 21 during the above described celebration activity. Additionally, in one embodiment, the player may have the option of terminating only the vibrating effect while the other features continue.

In another embodiment, lighting effects are used during the presentation of the celebration activity. For example, during the presentation of a celebration activity, lights (not shown) on the gaming machine 10 may flash dramatically to develop a sense of fanfare around a winning player. Additionally, other lighting effects capable for use during a celebration activity include, but are not limited to, pulsating light effects, backlighting, black lighting and colored lighting. In one embodiment, lights are strategically placed about the exterior of the gaming machine 10 (not shown). In this and other similar embodiments, during the presentation of a celebration activity, the lights are selectively turned on and off to create various effects. For example, the lights may sequentially turn on and off to give the illusion of spinning. The lights may be conventionally controlled by circuitry tied to the gaming machine processor and software. Additionally, the lights may flash different colors to create a particular effect. For example, some lights may flash blue, while other lights flash red. It may further be appreciated that the lights may comprise light emitting diodes (LEDs) with red-green-blue or similar coloring which came be activated according to an algorithm or pattern to cause particular visual affects that generate excitement or entertainment to a player.

In yet another example, the celebration activity incorporates one or more special effect features. The special effects may include, but are not limited to, the presentation of laser lights, holograms, scent effects and the emission of mist or fog. Optionally, a celebration activity may also incorporate temperature changes. For example, during the presentation of a particular celebration activity, the temperature around the gaming machine may noticeably decrease. Alternately, the temperature around the gaming machine may noticeably increase during the presentation of a celebration activity.

Those skilled in the art will appreciate that a celebration activity may incorporate a countless number of features, whether alone or in combination. Additionally, the features used in the celebration activity may be configured and defined by the casino, or a casino operator. In one embodiment, a casino receives a gaming machine from a manufacture, wherein the gaming machine has pre-configured features for use with the celebration activities. The casino has the capability of reconfiguring the celebration activities, including adding or deleting celebration features.

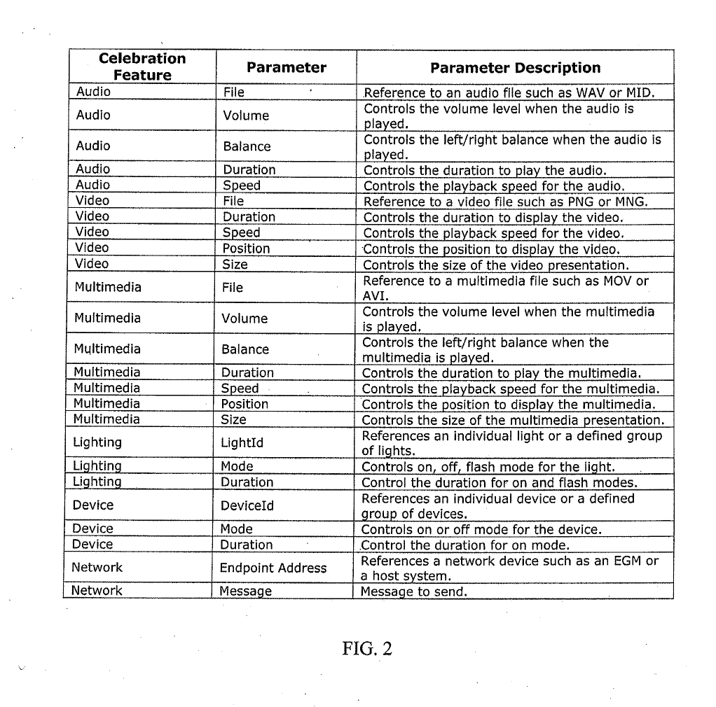

A listing of example celebration features and associated parameters are presented in a table in FIG. 2. As will be evident to those skilled in the art with reference to the disclosed table, variations in the order or inclusion of additional features and/or parameters will be possible.

In one embodiment, the celebration activity may be presented as pre-defined combinations of one or more features. Additionally, the celebration activity may be presented as the random selection of a single combination of features from a library of pre-defined feature sets. The random selection may use a bias factor for weighting the frequency at which each of the pre-defined feature sets is selected. Those skilled in the art will appreciate that any frequency could be used. Optionally, in another embodiment, the celebration activity may include multiple celebrations chained together in a sequence.

Additionally, in various embodiments, a casino configures the celebration activities. More particular, the casino may determine the number of celebration activities available for use in a gaming system, and the casino may also define the various features that are included in particular celebration activities. Optionally, in another embodiment, the celebration activities are pre-determined by a manufacturer, but may be reconfigured by a casino. The configured celebration activities are then stored in a storage device. In one embodiment, a library of defined celebration activities is stored on the gaming machine 10. In an optional embodiment, a library of defined celebration activities is stored in a memory device in a casino gaming system, wherein the gaming machine 10 may access the memory device.

In various embodiments, a celebration activity is activated upon the occurrence of a triggering event. In some embodiments, the casino determines which actions are defined as triggering events. Optionally, a manufacturer may predefine the triggering events, but the casino may reconfigure the events that will actually trigger the activation of a celebration activity.

In an optional embodiment, a triggering event may also be configured to terminate particular celebration activities. Those skilled in the art will appreciate that a vast variety of activities and game functions may be defined as triggering events. For example, the action of using a player tracking identification device may be defined and configured as a triggering event. More particularly, the insertion of a player tracking identification device into a gaming machine 10 may trigger a particular pre-defined celebration activity. Optionally, the removal of a player tracking identification device may trigger a particular, pre-defined celebration activity, which may be the same celebration activity as triggered by insertion of the player tracking identification device. Alternately, removal of a player tracking identification device may trigger a celebration activity different than the one triggered by the insertion of the player tracking identification device. Additionally, in another optional embodiment, the application of a player tracking identification device triggers the activation of celebration activity. More particular, in a player tracking device having a wireless transmitter, the mere detection of the transmitted signal from the device may be a triggering event. Optionally, in an alternate embodiment, the signal detection in combination with identification of the tracking device is defined as a triggering event.

Another example function or activity that may be configured as a triggering event is directed towards the game winning level. Typically, in a game, the various resulting winning combinations have different values. Additionally, the values of the winning combinations may be categorized into various levels by the casino operator, wherein each level may comprise a range of values. In one embodiment the occurrence of a particular game winning level triggers a particular celebration activity. For example, in poker, a ‘three-of-a-kind” is a particular winning hand that refers to a particular win level, and a “four-of-a-kind” is a different particular winning hand that refers to a higher win level. In other words a “four-of-a-kind” is a higher level win as compared to the “three-of-a-kind.” For this example, the occurrence of a “four-of-a-kind” would trigger the activation of a celebration activity different than the celebration activity that would be presented if a “three-of-a-kind” had occurred.

Optionally, additional examples of functions or activities that may be defined as triggering events include, but are not limited to, the occurrence of a particular win amount, credit-in activity, credit-out activity, the occurrence of a system bonus award, game idle period, game activity, player activity and an external signal. Typically, credit-in activity refers to adding credits to the gaming machine 10. The credits may be added via a gaming device such as, but not limited to, a coin acceptor, bill acceptor, voucher, WAT, and smart card. Generally, credit-out activity refers to cashing out credits from the gaming machine 10 via such devices as, but not limited to, a hopper, voucher, WAT, and smart card.

Typically, a system bonus award is a prize or amount awarded to a player. For example, in one embodiment, the configured triggering event may be defined as the awarding of a bonus between 25 and 200 credits. In some embodiments, the occurrence of the defined event triggers celebration activity.

The game idle period refers to the time when the gaming machine is not being played. A trigger event may consider the game idle period. For example, in one embodiment, a game idle period is defined as no credits received and no activity for five minutes. Once the defined game idle period occurs, a celebration activity is triggered. Those skilled in the art will appreciate that the game idle period may be defined as any amount of time.

Game activity and player activity are directed to actions from a game perspective and a player perspective, respectively. For example, game activity may include receiving a player's wager. Additionally, player activity may include a player pressing the service or help button.

Optionally, external signals may be configured to be a triggering event. For example, in one embodiment, receiving a network message triggers a celebration activity.

The functions and/or actions defined as triggering events may have associated parameters that modify the event for specific criteria. For example, for the game win level, parameters such as the bet amount and win level may further define the event. More particularly, in a poker game, an event may be configured to require a maximum bet in addition to a resulting “full-house” in order to trigger the activation of a celebration activity. For this example, the mere presence of a resulting “full-house” will not activate the celebration activity unless the player also initially wagered the maximum bet amount.

In another example, the trigger event is defined as having a range of parameters. For example, using the poker reference, an example “Event102” is configured to trigger a celebration activity only if a maximum bet was placed, and if the win generates an amount between 50 and 100 credits inclusively. In another example, an “Event 103” is configured to trigger a celebration activity when any network message from a specific host is received. Those skilled in the art will appreciate that any combination of parameters may be used to define a triggering event.

Additionally, in various embodiments, the one or more triggering events are defined and configured by a casino or casino operator. The configured triggering events are then stored in a storage device. In one embodiment, a library of defined triggering events is stored on the gaming machine 10. In an optional embodiment, a library of defined triggering events is stored in a memory device in a casino gaming system, wherein the gaming machine 10 may access the memory device.

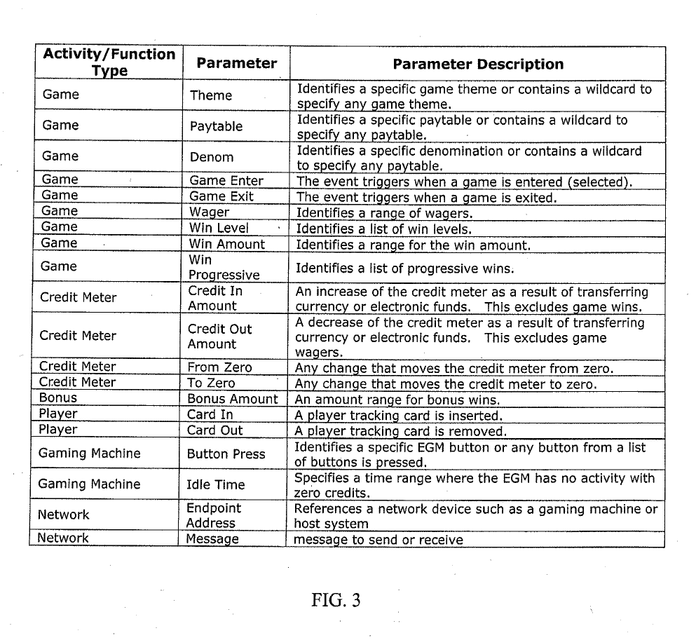

As previously discussed, the various functions and activities of the gaming system may be defined as triggering events. The various functions and activities may include one or more defining parameters. A table listing example activities/functions and associated parameters is presented in FIG. 3. As will be evident to those skilled in the art with reference to the disclosed table, variations in the order or inclusion of additional activities/functions and/or parameters will be possible.

In various embodiments, the celebration activities and triggering events are associated via a configurable method. More particularly, a triggering event is bound or associated with one or more particular celebration activities. This association indicates that upon the occurrence of a particular triggering event, a celebration activity associated with the particular event trigger is activated and presented.

A library of associations, or bindings, may be stored on a gaming machine 10. In some embodiments, the library of associations is a sort of map that binds or links one or more defined triggering events to one or more specific celebration activities. Alternately, the library of associations may be stored on a network, accessible to the gaming machine. In one example, a defined “Event101” triggers the activation of a “Celeb001.” An ASSOC101001 links the Celeb001 to the Event101. Alternately, in another example, an event may be configured to terminate the presentation of a celebration activity.

In some embodiments, the features presented in the celebration activities are defined to be intrinsic to the gaming machine's software. However, the content used for the features may be customized by providing a different audio file, movie file, etc. In one example embodiment, the appropriate files for content customization may be copied to a user partition on media used by the gaming machine. Alternately, in another embodiment, the gaming machine may download the customization content via a network interface.

Optionally, in another embodiment, celebration activities that use random selection or sequences have additional configuration capability. These capabilities may be configured via a configuration file copied to a user partition on media used by the gaming machine for celebration configuration. Alternatively, in an optional embodiment, these capabilities may be configured via an operation screen or downloaded over the network.

Additionally, in another embodiment the triggering events are defined to be intrinsic to the gaming machine's software. However, the triggering events may be customized by a casino. In another embodiment, the parameters of the triggering event may be customized and defined by the casino, including an authorized casino operator. In some optional embodiments, the same configuration capability can be used to define celebration activities, trigger events, and the associations binding the triggers events to particular celebration activities.

One embodiment of the configurable celebration system provides a configuration component for use by the casino, and more particularly, for use by authorized casino operators, to configure various aspects of the celebration system. In one embodiment, the configuration component is a tool that provides an interface for casino operators to: define the features presented in one or more celebration activities, define triggering events, and associate various triggering events with particular celebration activities.

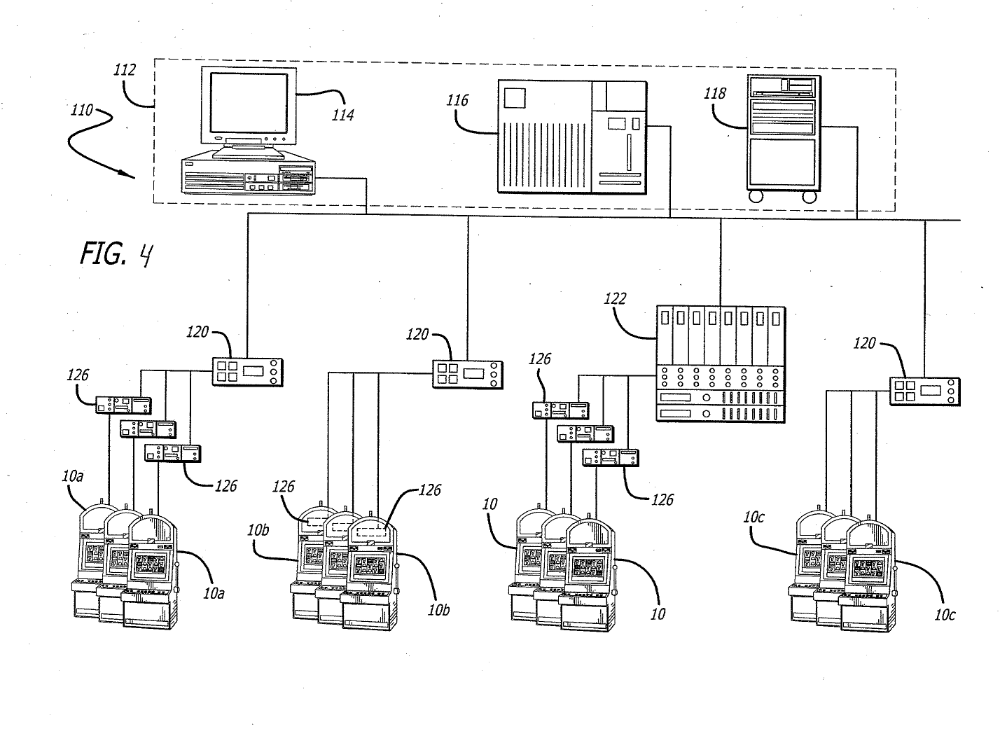

In one embodiment, the configuration component is operatively connected to a back end system. Referring to FIG. 4, a casino gaming system 110 is illustrated. The casino gaming system 110 comprises one or more gaming machines 10 operatively connected via a network to a back end system 112. In one embodiment, the back end system 112 includes a configuration component (not shown) for use with the configurable celebration system. As discussed above, the configuration component may provide the casino with an interface for defining and reconfiguring various aspects of the celebration activity. Additionally, in another embodiment, the configuration component may query one or more of the gaming machines 10 in the casino gaming system 110 to determine the celebration capability of each queried gaming machine 10 so that only meaningful celebrations are configured for each gaming machine. For example, if it is determined that a particular gaming machine 10 does not have speakers, then it would not be meaningful or effective to configure a celebration activity having audio features for that particular gaming machine 10. In one embodiment, the configuration component automatically queries the gaming machines 10. Optionally, in an alternate embodiment, a casino operator interfaces with the configuration component, and sends out a particular query at his initiation. In another embodiment, the configuration component may query the gaming machines to determine the particular gaming-related content stored on the gaming machines. Furthermore, in an additional embodiment, the configuration component can automatically download information pertaining to celebration features onto one or more gaming machines. Optionally, the configuration component may also copy celebration related data from one gaming machine and may send the copied celebration data to a second gaming machine.

Additionally, in an optional embodiment, celebration related data may be downloaded to one or more gaming machine dynamically. Alternately, celebration related data may be scheduled for download to one or more gaming machines. The configuration component may be used to configure the implementation of the downloading.

In another embodiment, the configuration component may be used to customize the celebration activity. For example, the celebration activity may be customized for certain days of the week. Additionally, the celebration activity may be customized to correspond to certain holidays. In another embodiment, the celebration activity may be customized for a certain player. For example, after recognizing a player from the inserted player identification card, the presented celebration activity may include features specific to the recognized player.

In an optional embodiment, the configuration component includes simulation capability. In one example, after a casino operator has configured the features and associated parameters for a particular celebration activity, the celebration activity may be simulated on a particular device or screen. The simulation provides the casino operator with a preview of the celebration activity.

Optionally, in another embodiment, the configuration component includes a portable, handheld device. In one embodiment, the handheld device may perform one or more of the same functions the configuration component that resides at the back end system. For example, in one embodiment, the handheld device includes simulation capability. The handheld device may be taken out on the casino floor and may interact wirelessly with one or more gaming machines. For example, a casino operator may point the handheld device at a particular gaming machine 10 and configure one or more celebration activities for the gaming machine. Once the configuration is complete, the handheld device may provide a preview of the resulting configuration. Optionally, in an alternate embodiment, the handheld device may physically connect with one or more gaming machines in order to configure the celebration activities.

One embodiment of the configurable celebration system incorporates security features. In particular, one embodiment provides a mechanism to authenticate the content of the various features presented in the celebration activity. Additionally, in another embodiment, the configurable celebration activities are checked against their associated configurable event triggers. Optionally, in one embodiment, the security mechanism uses two strategies for preventing non-authenticable content and/or invalid configurations. The first strategy authenticates the content of one or more of the features of the celebration activity, and the second strategy checks the permission of the content of one or more of the features.

One security concern is that inappropriate or unauthorized celebration content may be placed on a gaming machine and then configured into the celebration system. In one embodiment, this concern is addressed by implementing an authentication scheme for all content of the celebration activities. In one embodiment, the authentication scheme requires the content of each feature to be digitally signed by an authority entity with a secure hash. The digital signature is stored in a reserved section of the content files called the header. The gaming machine may then ‘authenticate’ the content by independently calculating the digital signature of the content. If the calculated digital signature matches the digital signature in the header, the content is considered authentic. Otherwise the content is deemed to be unauthorized.

Another concern is that authorized content may be associated with inappropriate events. For example, a poker game may be inappropriately configured to associate a “Full House” win level event trigger with a celebration containing a “Royal Flush” multimedia feature. In one embodiment, this error is addressed by incorporating a permission checking scheme. More particularly, in one embodiment, a list of permissions is stored in the file header. The permissions identify the restrictions for use of the content. In other words, the permissions identify the events and parameters, or groups of events, or parameter ranges for which use is allowed. The permissions are cross-checked during configuration of the associations (e.g., the associations between trigger events and celebration activities), thereby allowing only the association of celebration activities and trigger events that match permissions. An attempt to configure an association between an event trigger and a celebration activity, where the permissions have been mismatched, will be rejected by the configuration console. This may include both direct configuration at the gaming machine and remote configuration through a network.

In one embodiment, the configurable celebration system provides for operator configuration to customize the presentation. Optionally, in another embodiment, the architecture minimizes risk of rogue content and invalid configurations by virtue of the security schemes that use authentication and permission sets.

In an optional embodiment, celebration activity may be coordinated across multiple gaming machines in a casino gaming system. For example, in one example embodiment, a group of gaming machine's may be configured to flash their bezel lights and generate an audio tone with duration of one second, whenever one or more of the gaming machines has a win over 499 credits. Optionally, in one embodiment, the flashing lights and emitted sound form a pattern, where the first gaming machine to win over 499 credits flashes and sounds first, followed by the two machines adjacent to the first machine, and then the next machine, and so on. Additionally, the multiple gaming machines can be configured to create a pattern of light, such as a moving wave of light, during a celebration activity. Optionally, in another embodiment, the celebration activity may be configured to occur along a bank of gaming machines.

Additionally, in the above described embodiment, a network celebration host may coordinate this activity. Referring back to FIG. 4, in one embodiment, the network celebration host resides on the back end system 112. As previously described, the casino gaming system 110 comprises one or more gaming machines 10. In various embodiments, any of the gaming machines 10 may be any type of electronic or mechanical gaming devices, such as, but not limited to, a mechanical reel spinning slot machine, video slot machine, video poker machine, keno machine, video blackjack machine, or a gaming machine offering one or more of the above-described games. Examples include, but are not limited to, the 56000 mechanical reel spinner and the Alpha video slot machine from Bally Gaming. Additionally, one or more of the gaming machines 10 may comprise one or more data repositories for storing data. Examples of information stored by the gaming machines 10 include, but are not limited to, accounting data, maintenance history information, short and/or long-term play data, real-time play data, sound data, celebration activity data, and triggering events data. The sound data may include, but is not limited to, audio files, sound clips, way files, mp3 files and sound files saved in various other formats. Furthermore, each gaming machine 10 comprises an audio system (not shown) for outputting sound.

The gaming machines 10 are connected via a network to a network bridge 120, which is used for networking, routing and polling gaming machines. The network bridge 120 connects to a back end system 112. Optionally, the gaming machines 10 may connect to the network via a network rack 122, which provides for a fewer number of connections to the back end system 112. Both network bridge 120 and network rack 122 may be classified as middleware, and facilitate communications between the back end system 112 and the gaming machines 10. The network bridges 120 and network rack 122 may comprise data repositories for storing network performance data. Such performance data may be based on network traffic and other network related information. Optionally, the network bridge 120 and the network rack 122 may be interchangeable components. For example, in one embodiment, a casino gaming system may comprise only network bridges and no network racks. Alternatively, in another embodiment, a casino gaming system may comprise only network racks and no network bridges. Additionally, in an alternative embodiment, a casino gaming system may comprise any combination of one or more network bridges and one or more network racks.

The back end system 112 may be configured to comprise one or more servers. The type of server employed is generally determined by the platform and software requirements of the gaming system. In one embodiment, as illustrated in FIG. 3, the back end system 112 is configured to include three servers: a slot floor controller 114, a casino management server 116 and a casino database 118. The slot floor controller 114 is a part of the player tracking system for gathering accounting, security and player specific information. The casino management server 116 and casino database 118 work together to store and process information specific to both employees and players. Player specific information includes, but is not limited to, passwords, biometric identification, player card identification, and biographic data. Additionally, employee specification information may include biographic data, biometric information, job level and rank, passwords, authorization codes and security clearance levels.

As described above, the network celebration host may organize celebration activity presented on one or more of the gaming machines 10. For example, in one embodiment, the network celebration host receives a report of the particular gaming machine to first report a win over 499 credits. Upon receiving the generated message, the network celebration host enters a mode where the host sends event triggers to multiple gaming machines in a defined sequence. The first gaming machine receives the first network message, the two adjacent gaming machines each receive network messages one second later, and so on. As each gaming machine receives its network message event trigger, the receiving gaming machine will invoke the associated celebration activity. For example, the first gaming machine, which receives its event trigger first, will flash its lights and sound its tone. The next gaming machines will receive their network message (which includes event triggers), and respond similarly. The process will continue as defined or configured by the casino.

In one embodiment, the configurable gaming system may categorize the defined celebration activities into a hierarchical arrangement. In other words, the celebration activities are classified according to a pre-determined ranking system. In one example embodiment, the configurable gaming system incorporates a hierarchical system of celebration graphics. Generally, celebration graphics refer to a graphical depiction that is presented after a winning outcome on a gaming machine. Examples of celebration graphics include, but are not limited to, a two-dimensional image, a three-dimensional image, an animated graphic, a photograph and movie clips. Optionally, the presentation of the celebration graphic may include sound (e.g., music, dialogue, or sound effects). Generally, in various embodiments of the hierarchical system, the duration and features of a particular celebration graphic correspond to the value of the winning outcome. Essentially, any form or combination of media may be used to create and present a celebration graphic. Optionally, in an alternate embodiment, the configurable celebration system includes a hierarchical system of celebration activities. As previously discussed, celebration activities may include graphic features, such as celebration graphics. Additionally, celebration activities may also include other types of features such as, but not limited to, audio presentations, multimedia presentations, lighting effects, general device control, sending and receiving network messages, and any other visual presentations not covered under the celebration graphics category. Further, the celebration activity may include one or more of the aforementioned features, in any combination.

Referring back to FIG. 1, in one embodiment, the gaming machine 10 is capable of displaying one or more games on the display 12. A game player activates a game on the gaming machine 10 and the resulting game outcome is shown on the display 12. If the resulting game outcome includes a winning combination of symbols, then one or more celebration graphics corresponding to the value of the winning combination are shown on the display 12. For instance, in one embodiment winning combinations having payout values in the range of 1-10 credits are associated with a particular celebration graphic, and payout values in the range of 10-100 credits are associated with a more elaborate celebration graphic. Additionally, the jackpot payout may be associated with the most elaborate celebration graphic. In this manner, the gaming machine provides a player with incentive to play the game to view the various celebration graphics. As a result, the gaming device creates and maintains more excitement for a player. As those skilled in the art will appreciate, the payout values may be categorized into a variety of ranges. Accordingly, the above example is merely one illustration of such payout ranges and is not intended as a limitation. Additionally, the casino may configure and define the variety of ranges.

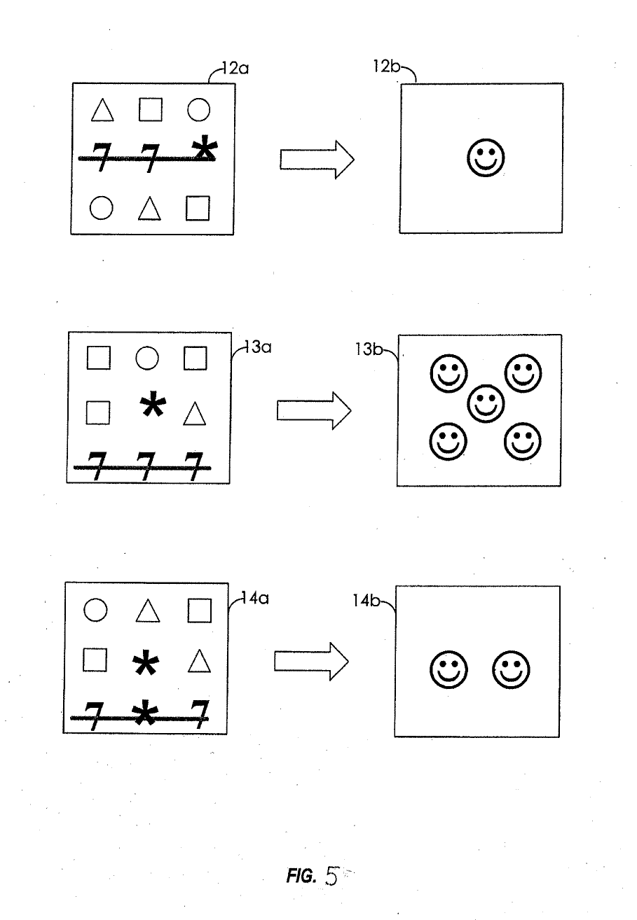

Referring now to FIG. 5, an initial gaming machine display 12a and a resulting gaming machine display 12b are shown. The initial gaming machine display 12a shows the winning combination “7 7*” in the display window. The occurrence of this winning combination triggers the presentation of a celebration graphic, which is shown in the resulting gaming machine display 12b.

Also shown in FIG. 5 are an initial gaming machine display 13a and a resulting gaming machine display 13b. The occurrence of the winning combination “7 7 7” is shown in the initial gaming machine display 13a. This winning combination has a larger payout value than the winning combination shown in the first initial gaming display 12a. As a result, this winning combination triggers the presentation of a different celebration graphic than the one presented in resulting gaming machine display 12b. The celebration graphic shown in the resulting gaming machine display 13b includes five symbols while the celebration graphic shown in display 12b only includes one symbol. When the winning combination for the jackpot occurs, an even more elaborate celebration graphic (not shown) is presented.

In one embodiment, the triggering event that activates the celebration graphic is the occurrence of one or more winning combinations on the display 12, in FIG. 1. Depending upon the value (which corresponds to the odds of achieving the winning outcome), a corresponding celebration graphic is displayed. In another embodiment, the triggering event is the occurrence of a bonus symbol on a payline.

Generally, most games have a variety of winning symbol combinations and a particular payout value is associated with each of the winning symbol combinations. One embodiment configures a hierarchy of winning symbol combinations based on the associated payout value of each. Typically, the manufacturer or the casino determines the particular payout scheme of a game and assigns payout values to the various winning symbol combinations. Additionally, in one embodiment, the casino may reconfigure and alter the scheme designed by the manufacturer. In one embodiment, the assigned payout values are based on a standard payout table. Alternatively, in another embodiment, the assigned payout values are based on a non-standard payout table. Optionally, in another embodiment, the payout scheme includes scatter pays, wherein the scatter pay is a win comprising non-adjacent symbols. Referring to FIG. 5, the winning combination “7*7” shown in the initial gaming machine display 14a is a scatter-pay-win. As such, the winning combination triggers the occurrence of a particular celebration graphic corresponding to the value of the winning combination (i.e., “7*7”).

In an optional embodiment, the payout scheme includes a transposed pay table, wherein the transposed pay table applies to symbol combinations that are in reverse order as compared to a standard pay table. That is, winning combinations are generally read from left to right. However, when using a transposed pay table, the winning symbol combinations are reversed such that the winning combinations are “read” right to left. For example, referring to FIG. 5, the standard table pays out coins for a “7 7*” symbol combination as shown in display 12a. A transposed pay table would pay out for a “*7 7” combination (not shown).

In one embodiment, the amount of time the celebration graphics are presented on the display corresponds to the value of the winning combinations. As those skilled in the art will appreciate, the varying values of the winning combinations range from a predetermined minimum value to a predetermined maximum value. For instance, a small winning amount (e.g., 10 credits) will prompt the display of a simple celebration graphic. For example, the simple celebration graphic is short in duration (e.g., 2 seconds). For a larger winning amount (e.g., 25 credits) the celebration graphic is longer in duration (e.g., 5 seconds). For an even larger winning amount (e.g., 100 credits) the celebration graphic is even longer in duration (e.g., 10 seconds). As those skilled in the art will appreciate, the duration of the celebration graphic may be programmed by the manufacturer or casino operator. Additionally, the values of the winning combinations may be categorized into various levels by the manufacturer or casino operator, wherein each level may comprise a range of values. As those skilled in the art will appreciate, an infinite number of categorizations is possible.

In another embodiment, the complexity of the presented celebration graphic varies and depends on the values of the winning combinations. Likewise, in a similar embodiment, the complexity of the presented celebration activity depends on values of the winning combinations. For instance, a small winning amount (e.g., 5 credits) will prompt the display of a simple celebration graphic. For example, the simple celebration graphic is a picture of one symbol. For a larger winning amount (e.g., 50 credits) the celebration graphic is more complex. For example, the more complex celebration graphic may be a picture comprising ten (10) animated symbols. For an even larger winning amount (e.g., 250 credits) the animated graphic may comprise fifteen (15) animated symbols and may include sound. As those skilled in the art will appreciate, the duration of the celebration graphic may be programmed by the manufacturer or casino operator. Additionally, the values of the winning combinations may be categorized into various levels by the manufacturer or casino operator, wherein each level may comprise a range of values. As those skilled in the art will appreciate, an infinite number of categorizations are possible.

In one embodiment, the payout values of the winning combinations are categorized into five different levels. Referring to FIG. 6, a table illustrating the five different levels of payout values is shown. Level one includes winning combinations having payout values ranging from 1 to 10 credits. Level two includes winning combinations having payout values ranging from 11 to 24 credits. Level three includes winning combinations having payout values ranging from 25 to 49 credits. Level four includes winning combinations having payout values ranging from 50-99 credits. Level five includes winning combinations having payout values ranging from 100 credits to a predetermined maximum number of credits. A particular celebration graphic and the duration of its display are associated with each level. For example, a winning outcome worth 2 credits corresponds to a “level one” win. Accordingly, for a level one win, a simple “one symbol” celebration graphic is displayed for one second. As seen in the table shown in FIG. 6, the celebration graphics vary according to the level of the winning outcome. As those skilled in the art will appreciate, multiple configurations for winning outcome levels are possible. The table shown in FIG. 6 is merely illustrative and does not serve to limit the levels of payout values to the ranges specified in the example.

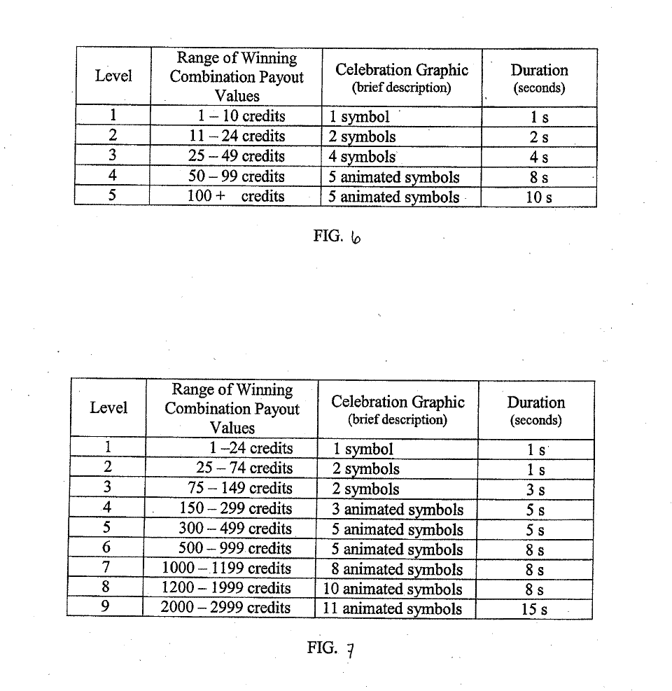

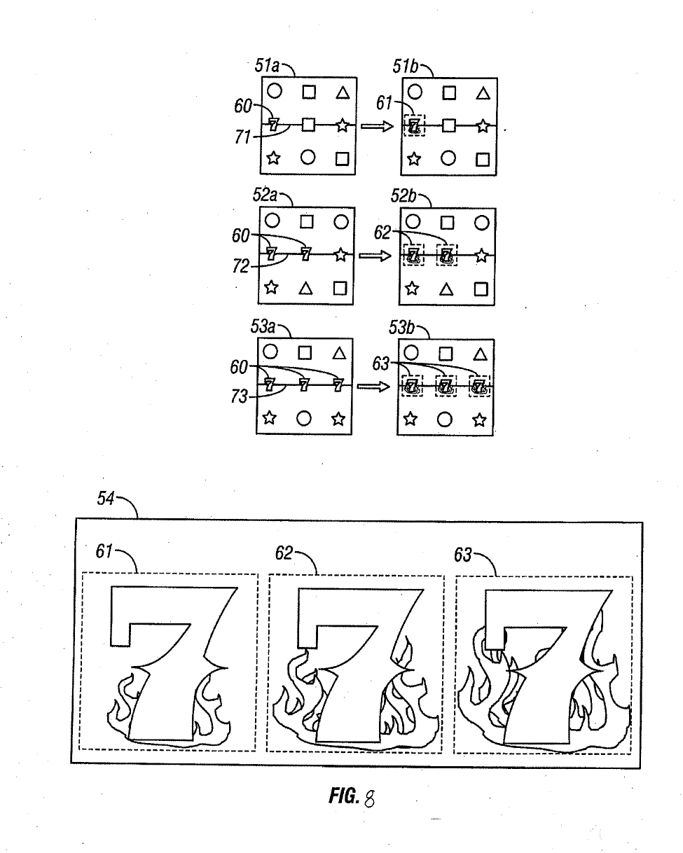

In another embodiment, the winning combination payout values are categorized into nine different levels. Referring to FIG. 7, a table illustrating the nine different levels is shown. A particular celebration graphic and the duration of its display are associated with each level. As those skilled in the art will appreciate, any number of levels may be defined and the table shown in FIG. 7 does not serve to limit the levels of payout values to the ranges specified in the example.

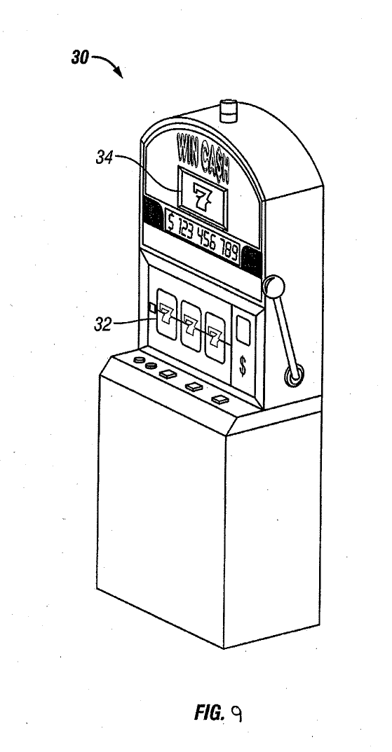

In one embodiment, the celebration graphics are in the form of substitution symbols. For example, when a symbol on the gaming machine display is part of a winning combination, the symbol is substituted with an animated symbol to denote a win. Referring now to FIG. 8, various symbols in a video reel game are shown on the display 51a. In this particular example, when a red “7” symbol (not shown in color in FIG. 8) is part of a winning combination, the red “7” symbol “changes” into an animated “7” with a blazing fire surrounding the number. In other words, the red “7” symbol is substituted with an animated symbol having fire that appears to blaze. In one embodiment, the amount of time the animated symbol is displayed depends on the value of the win. In another embodiment, the content of the animated symbol depends on the value of the win.

Referring back to FIG. 8, a winning line 71 is shown in the display 51a. In this example, the winning line 71 is a small win and as a result the red “7” symbol 60 is substituted with an animated symbol 61 having a “small fire” surrounding the number “7” (as shown in display 51b). In the display 52a, a winning line 72 having two red “7” symbols 60 is shown. In display 52b, each of the red “7” symbols 60 have been substituted with an animated symbol 62. Since the winning line 72 is worth more than the winning line 71, each of the animated symbols 62 have animated fire larger than the animated fire in the animated symbol 61. Additionally, the display 53a shows a winning line 73 having three red “7” symbols 60. The winning line 73 is a “big win” and as a result each red “7” symbol 60 in winning line 73 is substituted with an animated “7” 63 having a big blazing fire, as shown in display 53b. A table 54 showing blown-up versions of animated symbols 61, 62 and 63 is provided in FIG. 8. As those skilled in the art will appreciate, the types of animated graphics used as substitution symbols will vary according to the needs of the game.

In one embodiment the win values are divided into various levels and each level is associated with a particular celebration graphic. For example, when a first level win (the smallest win) occurs, a red “7” is substituted with an animated blazing “7” for one second. The animated figure appears to burn for the one second it is displayed on the screen. For a second level win, the red “7” is again substituted with an animated blazing “7”, but is displayed for two seconds. For a third level win, a red “7” is substituted with an animated blazing “7”. However, in the celebration graphic associated with a third level win, the fire surrounding the “7” blazes higher and more fiercely than the fire shown for the lower level wins. Additionally, the blazing fire is displayed for three seconds. For a fourth level win, one or more red “7”s are substituted with an animated blazing “7” for at least three seconds. For the highest level win, one or more red “7”s are substituted with an animated blazing “7” and then the entire screen turns into a raging inferno and fire engine sounds are heard. In an alternate embodiment, sound accompanies the display of the animated blazing “7” for any level win. Optionally, the sound may simulate the sounds of a fire blazing.

In another embodiment, the features of the celebration graphic are based upon two factors such as the winning combination and the amount of the player's wager. For instance, a small winning combination and a small wager result in a short and simple celebration graphic. If the winning combination has a small value, but the player has made a maximum bet, the celebration graphic may be longer in duration and more complex. As those skilled in the art will appreciate, the factors that affect the duration and complexity of the celebration graphic may be determined and configured by the manufacturer or casino operator.

In an alternative embodiment, the celebration graphic is an interactive celebration graphic. The celebration graphic may include player data such as, but not limited to, player name, player birthday, or an image of the player. In an optional embodiment, the interactive celebration graphic may include a character or other animated graphic announcing the player's name. Alternatively, a banner may display the player's name. In another embodiment, the player's data may be obtained when the player inserts a player tracking card into the gaming machine. Optionally, the player data may be obtained when a player inputs biographical data into the gaming machine. In yet another embodiment, the gaming machine may include a camera to capture an image of the player. This image may then be incorporated into the celebration graphic.

In another embodiment, the celebration graphic may be interactive in that the player can terminate the celebration graphic before the end of the graphic. Optionally, the player can mute the music or dialogue that is also presented with the celebration graphic.

In another embodiment, the celebration graphic is generic to the gaming machine. For instance, the celebration graphic may flash on the display screen, “Congratulations! You've won 10 credits!” and have a graphical depiction of floating balloons, streamers, and sound makers. The complexity of the celebration graphic increases with more graphical features and sounds for larger winning combinations. Furthermore, the duration of the celebration graphic may be longer for higher winning combinations.

In another embodiment, the celebration graphic corresponds to the theme of the game. In one example, the theme of a gaming machine is “Gold Rush.” For a small winning combination, the celebration screen may show a character finding a small amount of gold. The character may then briefly dance, holler or hum a tune. For a large winning combination, the celebration graphic may show a character finding a large amount of gold, and, then the character may start singing and dancing for a longer amount of time. As those skilled in the art will appreciate, the elaborate nature of the graphic depends upon the amount of the winning outcome.

In an alternative embodiment, the celebration graphic may be based on such factors as time, date, weather, etc. For example, if a player is playing a game on July 4^{th}, the celebration graphic presented might be fireworks. As those skilled in the art will appreciate, the firework themed graphics may vary in complexity to correspond to the win amount. Optionally, in another embodiment, the celebration graphic incorporates features of current weather conditions. For example, if the weather is raining, the celebration graphic could include an animated rainfall. Alternatively, the time of day may be incorporated into the celebration graphic. For example, in the morning, the celebration graphic could include an animated display of the sun rising.

In one embodiment, the gaming machine comprises more than one display. Referring now to FIG. 9, the gaming machine 30 comprises a first display 32 and a second display 34. In another embodiment, the first display 32 of the gaming machine 30 displays mechanical reels (not shown). The second display 34 presents a celebration graphic upon the occurrence of a winning combination. Alternatively, in one embodiment, the celebration graphics are presented only on the first display 32. In another embodiment, the celebration graphics are only presented on the second display 34. In yet another embodiment, the celebration graphics are presented on both the first and second displays 32 and 34. Optionally, in an alternate embodiment, a gaming machine may have more than two displays (not shown) and celebration graphics may be presented on any combination of the displays.

Additionally, various embodiments of the gaming machines include a microprocessor for determining whether a prize is to be awarded based upon the outcome of the game (not shown). The microprocessor also determines whether a triggering event is present to initiate the presentation of a celebration graphic.

Optionally, another embodiment provides a method for celebrating winning symbol combinations for a game on a gaming machine. The method comprises beginning play of the game on the gaming machine. At the prompt of a user, one or more symbols are presented on a gaming machine display. Next, it is determined whether the combination of presented symbols matches predetermined winning symbol combinations. The winning symbol combinations have varying values. A memory storing a hierarchy of celebration graphics is accessed and the celebration graphic that corresponds to the value of the winning symbol combination is retrieved. The retrieved celebration graphic is then presented on the display to celebrate the winning symbol combination.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A gaming terminal of the type having a display, one or more speakers and an associated processing unit, apparatus for a player to interface with the processing unit to input a wager, play a game resulting in a winning or losing outcome and for which the player receives an award for a winning outcome and connectivity for communication through a network with a host processor, said gaming terminal comprising:
a first data storage device storing data representing audio and video celebration presentation files, said data files configured to control said gaming terminal to present different audio and video celebratory presentations at said gaming terminal after occurrence of a triggering event;
a second storage device storing data representing celebratory triggering events, each triggering event detectible by one of said processing unit and said host and said triggering events selected from a group consisting of an award after a play of the game and an event independent of the play of the game;
a library of celebration bindings each associating each triggering event with a celebration presentation file, said library configurable to alter said binding associations to change the celebration presentation file and resulting celebratory presentation bound to at least one triggering event.

2. The gaming terminal of claim 1 comprising said second storage device storing data representing celebratory triggering events for a plurality of award amount levels and said library of celebration bindings including a binding to a different one of an audio and visual celebratory presentation for each of said award amount levels.

3. The gaming terminal of claim 2 wherein said gaming terminal includes an interface with the host for the player to comprising said second storage device storing data representing a celebratory triggering event corresponding to the player enabling said interface.

4. The gaming terminal of claim 3 wherein said interface includes apparatus for identifying the player to the host comprising said second storage device storing data representing a celebratory triggering event corresponding to the player accessing said identification apparatus.

5. The gaming terminal of claim 1 comprising said first storage device is located remote to said gaming terminal and said host is configured to detect a triggering event, access said library to bind an audio video celebration presentation file and transmit said file to the gaming terminal over the network for presentation at said gaming terminal.

6. The gaming terminal of claim 5 comprising said second storage device is located remote to said gaming terminal.

7. The gaming terminal of claim 6 comprising said library is remote to said gaming terminal.

8. The gaming terminal of claim 1 comprising at least one celebration presentation file is unique to the player.

9. The gaming terminal of claim 1 comprising at least one celebration presentation file includes an image of the player.

10. In a system of the type including (A) a gaming terminal having (i) a display, (ii) one or more speakers and (iii) an associated processing unit, (iv) apparatus for a player to interface with the processing unit to input a wager, play a game resulting in a winning or losing outcome and for which the player receives an award for a winning outcome and (B) connectivity for communication through a network with a host processor, said system comprising:
a first data storage device located remote from said gaming terminal and storing data representing audio and video celebration presentation files, said data files configured to control said gaming terminal to present different audio and video celebratory presentations at said gaming terminal after occurrence of a triggering event;
a second storage device located remote from said gaming terminal and storing data representing celebratory triggering events, each triggering event detectible by said host and said triggering events selected from a group consisting of plural award amount levels from the play of the game and an event independent of the play of the game;
a library of celebration bindings at said host each associating each triggering event with a celebration presentation file, said library configurable to alter said binding associations to change the celebration presentation file and resulting celebratory presentation bound to a triggering event.

11. The system of claim 10 comprising said first storage device storing data representing component audio and video celebration presentation files, said component audio and video celebration presentation files configured to be combined to define a plurality of audio and video presentations and apparatus for randomly combining said component audio and video celebration presentation files to define an audio of video presentation at said gaming terminal for said celebratory presentation.

12. The system of claim 10 wherein said gaming terminal includes an interface with the host for the player to comprising said second storage device storing data representing a celebratory triggering event corresponding to the player enabling said interface.

13. A method for providing for a celebratory presentation at a gaming terminal of the type having a display, one or more speakers and an associated processing unit, apparatus for a player to interface with the processing unit to input a wager, play a game resulting in a winning or losing outcome and for which the player receives an award for a winning outcome and connectivity for communication through a network with a host processor, said method comprising:
providing a first data storage device storing data representing audio and video celebration presentation files, said data files configured to control said gaming terminal to present different audio and video celebratory presentations at said gaming terminal after occurrence of a triggering event;
providing a second storage device storing data representing celebratory triggering events, each triggering event detectible by one of said processing unit and said host and said triggering events selected from a group consisting of an award after a play of the game and an event independent of the play of the game;
enabling the binding of a triggering event with a celebration presentation file and enabling the alteration said binding for change the celebration presentation file and resulting celebratory presentation bound to at least one triggering event.

14. The method of claim 13 wherein said gaming terminal includes an interface with the host for the player to comprising storing at said second storage device data representing a celebratory triggering event corresponding to the player enabling said interface.

15. The method of claim 13 comprising storing at said first storage device at least one celebration presentation file unique to the player.

16. The method of claim 15 comprising storing at said first storage device at least one celebration presentation file including an image of the player.
